(19) United States
(12) Patent Application Publication
(10) Pub. No.: US 2002/0117960 A1
(43) Pub. Date: Aug. 29, 2002

(54) Field emission wafer and process for making same for use in field emission display devices

(76) Inventors: Jay J.L. Yi, Port Chester, NY (US); William J.S. Zhong, Stamford, CT (US); Jack C. Chou, Stamford, CT (US); Po-Ping Lin, Palo Alto, CA (US)

Correspondence Address: BRADLEY M GANZ, PC, P O BOX 10105, PORTLAND, OR, 97296

(21) Appl. No.: 09/944,227

(22) Filed: Aug. 30, 2001

Related U.S. Application Data
(60) Provisional application No. 60/229,962, filed on Sep. 1, 2000.

(51) Int. Cl. H01J 1/62

(52) U.S. Cl. 313/495

(57) ABSTRACT

A field emission wafer comprising an array of fused glass fibers, a plurality of fibers having an inner core glass of a bulk conductive glass and a clad glass that surrounds the core glass, the conductivity of the core glass being substantially higher than the clad glass, the core glass of the fibers having an upper portion with an emission tip formed thereon.

### BACKGROUND OF THE INVENTION

This invention claims the benefit of co-pending U.S. Provisional Application No. 60/229,962, entitled “FIELD EMISSION WAFER AND PROCESS FOR MAKING SAME FOR USE IN FIELD EMISSION DISPLAY DEVICES”, filed Sep. 1, 2000, the entire disclosure of which is hereby incorporated by reference as if set forth in its entirety for all purposes.

This invention relates to field emission devices having cathode emission tips for use in field emission displays (“FEDs”). More particularly, the present invention relates to field emission devices containing cold cathode emission tips of semi-conducting or bulk electronic conducting glass and a method of making same.

Cathode ray tubes (CRTs) historically have been the most dominant display technology. However, they are large and bulky, consume significant power, and require high voltages.

Active matrix liquid crystal displays (AMLCDs) are currently dominant low-power choice for flat panel displays. However, they also suffer from many problems including slow response times, lack of brightness, narrow viewing angles, and are expensive to manufacture.

FEDs are a promising low cost alternative to AMLCDs and CRTs for flat panel displays. They are thinner and lighter than CRTs and use less power. They also hold the promise of better image quality than cathode ray or liquid crystal displays. These qualities make FEDs a highly attractive solution to commercial, industrial and military needs. Such devices can be used as electron source devices for flat panel displays, microwave devices, ultra-sensitive chemical sensors, etc.

As shown in FIG. 1, a conventional FED consists of a non-conductive baseplate 1 with a matrix array of X-Y addressable cold cathode emission tips 2 and an opposing phosphor-coated transparent glass plate anode 3. Electrons are accelerated from the cold cathode tips toward the transparent plate anode where the phosphor 4 is induced into cathodoluminescence, just as in a conventional CRT.

The plates are separated by spacers 5 to maintain a constant cathode-anode distance, leaving a thin vacuum gap between the plates. The spacers typically are formed of high compressive strength materials that have ranged from polyamide layers of glass spheres. The spacers prevent outside atmosphere pressure from pushing the two plates together. An additional conductive grid layer 6 surrounding the cathode tips may also be applied to the baseplate to act as a triode gate and control the electron emission.

FEDs function like a cathode ray tube in that they each light a phosphor screen with electron beams. While cathode ray tubes use a single-point hot-electron source beam that is scanned across the screen to provide an image, FEDs use an addressable array of low voltage electron emitters to directly image an array of pixel areas on a phosphor screen at very short distances. This makes FEDs a prime candidate for high-resolution low power flat panel displays.

In convention FEDs, the field emitting cathode is generally a conductive or semiconducting crystalline pyramid formed on a non-conductive baseplate using a masking/thin film deposit technology.

The efficiency of the electron device depends on the structure and materials of the device, and on the shape of the cathode emitter. In conventional FEDs, the field emitting materials are generally conductive or semiconductive crystalline metal, diamond or diamond-like carbon tips. These are usually formed on the non-conductive baseplate using masking, vapor deposition, thermal treatment and etching processes. However, many important issues remain to be answered, including the optimum emitter, spacer and gate materials, and their shapes and relative arrangements. There is also a strong need to make the manufacturing of FEDs more cost effective. Currently, the process is relatively complicated, involving formation of multiple structures or features over multiple steps. For example, the emitters, spacers and gate use different materials and are formed through different processes and assembled in different steps.

The baseplate matrix in a FED is a critical component from which the foregoing problems largely stem. In the present invention, as discussed in full detail below, a field emission wafer for a baseplate is formed using a novel adaptation of microchannel plate technology.

As background for the discussion of the novel adoption, microchannel plates (“MCPs”) are formed from a fused parallel array of glass fibers that are sliced to form a thin wafer. The fibers are formed of common oxide glasses, which are mostly dielectric. Under high electric fields such dielectric oxide glasses may support low levels of conduction based on electrolysis with ion mass transfer. However, this class of glasses is not suitable for use in microchannel plates unless it receives a surface heat treatment with hydrogen. This process step converts a thin surface layer of the glass to provide electron conduction, which is necessary for device application. For example, a glass containing lead oxide can be reduced in hydrogen to give a thin electronically conductive surface layer. In such glasses, the bulk resistivity of the glass substrate remains high and the conduction mechanism remains ionic.

In addition to the hydrogen reduced semiconducting surface layer, there is a high silicon layer on top of it that exhibits secondary electrons when electrons strike the surface. These are accelerated and multiplied by the potential difference applied between the channel ends. Many practical problems arise from the application of this material behavior to MCP technology. To address such problems, bulk conducting glasses have been developed by the assignee of the present invention for use in conventional microchannel plates.

A “bulk conducting glass” (hereinafter referred to as “BC glass”) may be generally characterized in that (a) electrical conduction occurs predominantly by electrons (and/or holes) rather than by ions, and (b) the temperature coefficient of resistivity is negative.

Certain oxide glasses containing transition metal ions, such as V⁺⁵/V⁺⁴ and Fe⁺²/Fe⁺³, have electronic conduction. The conduction mechanism is the hopping process as explained by the Mott theory. Unlike covalent semiconductors such as doped Si and Ge, these oxide glasses (BC glass) have low conductivity. However, BC glass has a higher conductivity than common oxide glasses, and higher secondary electron emission coefficients than covalent semiconductors. They are believed to be good candidate materials for electron multiplication applications in such devices as electromagnetic detectors and night-vision imagers.

Baynton et al. first reported that a family of V₂O₅-P₂O₅ glasses was bulk electronically conducting rather than ionically conducting (J. Electrochem. Soc., Vol. 104, p. 237, 1957). The first widely studied systems were those containing V₂O₅ and Fe₃O₄, their conductivity was considered as “hopping” of electrons or vacancies between transition metal ions of different valance V⁺⁵/V⁺⁴ and Fe⁺²/Fe⁺³.

Novel glass compositions with bulk electronic conduction suitable for making field emission baseplates and other electro-opitcal devices are highly desirable for several reasons. Glasses can be made and formed into intricate shapes using well-known glass processing methods. For example, glass fibers can be drawn and redrawn down to several microns in diameter, allowing them to be made into intricate and highly ordered structures.

Unfortunately, BC glass compositions based on vanadium-phosphate have not been suitably developed for use in commercial applications. For example, U.S. Pat. No. 3,520,831 and U.S. Pat. No. 3,910,796 describe glass compositions having specific amounts of V₂O₅ and P₂O₅, as well as other specific ingredients. Notably, the '831 patent relates to surface coatings based on vanadium and phosphate compositions: the patent does not teach or suggest bulk conducting glass compositions that can be drawn into fine structures such as a fiber suitable for a microchannel plate. The '796 patent discloses specific BC-glass compositions based on vanadium-phosphate, but the patent also expressly directs that lead oxide, PbO, in the compositions, should not exceed 15 Mole % or the glass will have an inadequately high resistance to current. Unfortunately, contrary to the teachings of the present invention, this restriction on the amount of PbO is not necessary, and is a drawback that limits how workable the glass is.

### SUMMARY OF THE INVENTION

The novel aspects of the present invention address the aforementioned problems in the prior art. The present invention provides a novel device and process relating to a monolithic glass wafer with a multitude of electron emission tips and their spacers for use in FED devices. Preferably, the wafer is composed of an array of fused fibers, each fiber comprising a core glass and a clad glass, the core glass being a bulk conducting glass.

The present invention provides electron emitters that are made of bulk electronically conducting glass separated by integral glass spacers of less conducting glass, and a process for simultaneously making the aforesaid structures in the same steps.

The advantages of the novel device emitter, and bundled arrays thereof, and process include:

better uniformity and sharpness of the emission tips.

smaller pixel (emitter) pitch, which can be reduced to several microns,

the spacer height can be equal to the pixel pitch.

FEDs of the present invention may be manufactured using a process that forms the emission tips and spacers at the same time, using the same or similar materials, thereby simplifying the manufacturing process.

the pixel location can be tailored and locked on the original wafer before forming the emission tip.

wafer sizes of several inches can be readily achieved.

FEDs of the present invention are relatively thin and light.

FEDs of the present invention use low power

More particularly, the present invention relates to multi-element glass wafer assemblies that can be treated chemically to form uniform emitting tips recessed below the level of the wafer surface. These wafers would be used as components in field emission devices whereby the recessed fiber tips act as an emission tip and the fiber ends at the other surface would be position addressable. The phosphor surface layer in the faceplate can be positioned at the wafer top surface.

In one embodiment, the emitter tips are made from fibers of bulk conductive glass with electrical resistivity in the range of 10⁷ to 10¹³ ohm-cm (at ambient temperature). A suitable resistivity for the present invention is 5×10⁹ ohm-cm. In a preferred embodiment, the field emission wafer is composed of an array of fused fibers, each fiber comprising an inner core glass of a of bulk conductive glass with electrical resistivity in the range of 10⁷ to 10¹³ ohm-cm, and surrounding clad glass, the ratio of conductivity between the core glass to the clad glass being greater than 1000:1.

### BRIEF DESCRIPTION OF THE DRAWINGS

FIG. 1 shows a side view schematic of general details of a field emission display device from the prior art.

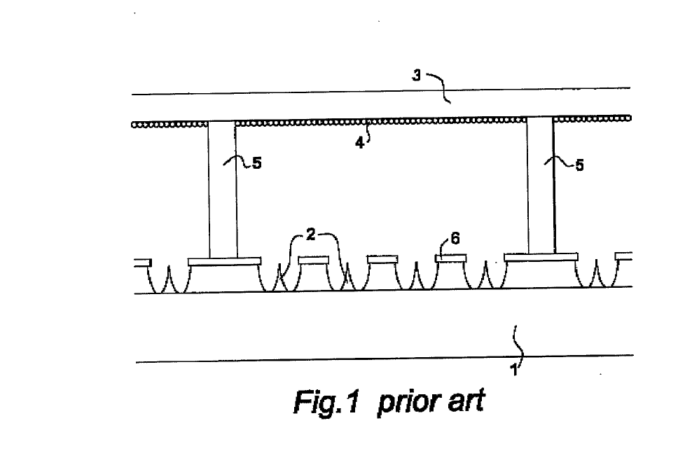

FIG. 2 shows a side view schematic of a field emission wafer (baseplate) and associated faceplate according to one embodiment of the present invention for use in a field emission display device.

FIG. 3 shows a side view schematic of a field emission wafer (baseplate) and associated faceplate according to a second embodiment of the present invention for use in a field emission display device.

### DETAILED DESCRIPTION OF THE INVENTION

The present invention provides an FED for flat panel displays, and methods related thereto. Other applications are microwave devices and ultrasensitive chemical detectors. A key component of an FED device is the “field emission wafer”. The present invention provides a novel field emission wafer. To the inventors' best knowledge, bulk conducting glasses have not previously been used on core glasses, and certainly not to form emission tips. In one embodiment, the wafer is structurally similar to conventional MCPs, except the inventors have developed a novel approach of using a bulk conducting core glass surrounded by an insulative clad glass. The core-clad arrangement is reversed, and a novel method is used to etch the core-clad structure to form emission tips and spacers.

In the most basic terms, a field emission wafer is a substrate containing an addressable array of cold-cathode emission tips. Electrons produced at the tips are accelerated toward a phosphor-coated transparent plate close to but separated from the tips. Electrons striking the phosphor are induced into cathodoluminescence. Typically, a baseplate wafer according to the present invention would contain millions of shaped conducting emission tips arranged in an ordered array.

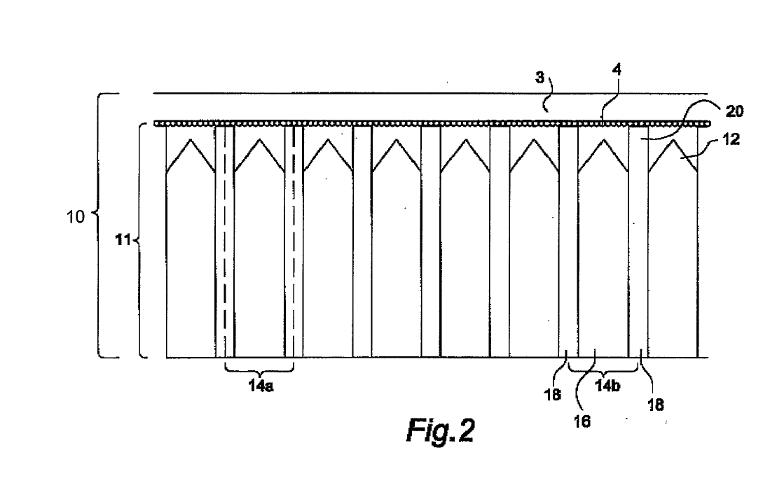

FIG. 2 shows one embodiment of an FED 10 according to the present invention, comprising a field emission wafer 11 with emission tips 12 and spacers 20. A faceplate 3 includes a phosphor surface coating 4 provides cathodoluminescence when electrons emitted by the tips 12 are accelerated onto the phosphor surface layer. The field emission wafer 11 is formed of vertically oriented, parallel fibers 14 in an ordered array. (The dashed line in fused fiber 14a is to represent the dividing line between adjacent fibers before they fuse together, as would occur in a conventional formation process well known to persons skilled in the art. It is to be understood that other fused fibers in the array, e.g., 14b, are formed in the same way.) Each fiber is formed of an elongate core glass 16 surrounded concentrically by an elongate clad glass 18. The core glass is made of bulk electronically conducting glass. The clad glass is electronically non-conductive. The core glass portion is etched or otherwise structured so that the core glass is shaped to provide an emission tip 12 on one surface.

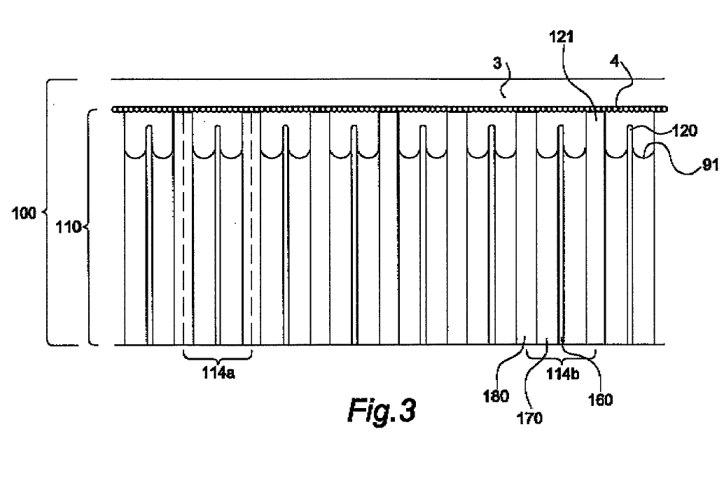

In the embodiment of FIG. 2, emission tips 12 are generally cone shaped. However other configurations terminating in relatively pointed ends or thin ends would also be suitable. For example, in the embodiment of FIG. 3, emission tips 120 are relatively blunt but thin. Accordingly, a variety of configurations may be used, so long as the ends provide a desired focusing or targeting effect on a target area. Persons skilled in the art may determine the appropriate parameters for an intended application without undue experimentation.

As can be seen in FIG. 2, the tips 12 are recessed within the upper portion 20 of surrounding clad glass 18. The upper portion 20 of the clad glass that extends above the emission tips serve as spacers to separate the tips 12 from the faceplate 3.

Each emission tip 12 or 120 is associated integrally or otherwise with a conductive lead for addressing. A preferred integral lead is the portion of the core glass that extends rearwardly from the emission tip 12 or 120 to the backside of the field emission wafer 11. Means for laying out addresses include masking and thin film deposition techniques known in the art.

Steps of Manufacturing Process:

One key aspect of producing a field emission wafer is the creation of sharp or thin emission tips 12. A novel aspect of the present invention includes etching back the core glass to produce sharp field emission tips while avoiding the need for emitter-to-faceplate spacers.

The following steps describe initial steps that may be used in forming a field emission wafer in accordance with the present invention:

(1) A core made of bulk electronically conducting glass is fitted into clad tube made of another glass less conducting than the core (preferably the ratio of conductivity for the core glass to the clad glass is greater than 1000:1); the core/tube set is heated and drawn to fiber of about 1 mm in diameter.

(2) The fiber with core and clad layer is cut into segments of equal length; several thousands of these segments are packed together into an ordered periodic array in a hexagonal bundle that is heated and stretched again into about 1 mm size in cross section.

(3) The hexagonal multi-fiber elements are cut into segments of equal length; the segments are packed together again, and fused to form a boule containing millions of pixels (in an ordered periodic array).

(4) The boule is sliced into wafers less than a few mm in thickness (depending on wafer size), both sides of the wafer are ground and polished.

(5) One side of the polished wafer, as described in the following section, is treated with an etchant to form tips with pointed or thin ends that are recessed in the surrounding clad glass, the extending clad glass comprising spacers.

Etch Process For Forming Emitter Tips

The wafers formed according to the foregoing steps 1-4 or other such means are chemically treated to expose fiber cores of bulk conductive glass in the form of emission tips 12, recessed within the surrounding non-conducting glass channels 18. The formation of the tips and spacers is determined by the etchant and etch conditions. The etchant may be any number of known etchants that etch glass compositions. The selection of an appropriate etchant and combination of glasses to achieve the desired structures is within the skill of persons in the art. In one embodiment of the invention, a 5% solution of HCl is an adequate etchant for a controlled etch that produces a preferential etching of the combination of glasses to produce recessed emission tips.

The conditions for the etch are such that the etchant creates a channel depth for the emission tip of a few hundred to a few thousand microns. The depth must be sufficient to avoid arcing between the cathode emitter tip and the anode phosphor plate and still allow the channel wall to act as a collimator for the emitted electrons, but not so deep that there will be inadequate electron intensity. A person skilled in the art will appreciate that other etchant conditions are also possible and will understand that the etch may vary according to the time, temperature, size and shape of the etch substrate.

### EXAMPLE 1

In one embodiment of the invention the field emission wafer is composed of an array of fibers formed from two different types of glasses. The bulk conducting core glass of the fibers used to make the FED may be one of several glasses in the iron-vanadium-lead-phosphate family of glasses. In these glasses the mole percentage of iron and vanadium controls the magnitude of the bulk conductivity, the lead oxide and other glass modifiers assist in the workability of the glass and the phosphate is the major glass forming oxide. Various other common oxides may also be added in small amounts to modify the glass properties in ways well known to persons skilled in the art. Similarly, the insulating clad glass of the fiber used to make the FED may be, for example, an alumina phosphate glass that is substantially less etchable in acid than the bulk conducting core glass. For example, an insulating core glass that is at least 1000 times less etchable in acid than the bulk conducting core glass would be suitable for use in the present invention. Various other common oxides may also be added in smaller amounts to modify the properties of this glass also in ways well known to persons skilled in the art. FIG. 2 shows an example of how the emitter tips 12 and spacers 18 would appear in vertical cross section following etching of this type of structure.

The process of assembling the starting fibers into an ordered hexagonal bundle for drawing into multi-fiber elements, then assembling these into a larger ordered array typically can produce a formation of millions of the tip-spacer elements in an ordered periodic lattice array. The distance between centers of these elements may be of the order of ten microns. However, the characteristics of using conventional glass forming techniques to form these structures permit the dimensions of these to be varied over wide limits. The dimensions of the bulk conducting core elements that are subsequently etched to tips may then be in the range of five to seven microns in diameter. Similarly, the same glass-forming techniques allow the ratio of clad thickness to core diameter to be easily varied by using tubes and rods of different tube and rod dimension.

In terms of arriving at a conical tip, one probable explanation for the preferential etch around the junction of core and clad glass giving the recessed pointed emission tips is that the core glass and clad glass normally have different coefficients of thermal expansions. Accordingly, during formation, the core and clad glasses cool at different rates leaving stressed regions at the junction. It is known that stressed glass materials etch faster than unstressed. Therefore in preferentially acting on the core glass, the stressed regions of the core glass etch faster, creating conical shaped tips. Other ways for a preferential etch could be to have a core glass that is made from a non-uniform composition such that the outer portion of the core etches faster using an etchant preferential for that outer portion.

### EXAMPLE 2

FIG. 3 shows another novel embodiment of an FED 100 in accordance with the present invention. The FED 110 has a faceplate 3 and a field emission wafer 110. As shown in FIG. 3, the field emission wafer 110 is composed of an array of fused fibers 114 formed from three different types of glasses in elongate, circumferential relationship. The bulk conducting core glass 160 of a fused fiber 114 used to make the FED again may be one of several glasses in the iron-vanadium-lead-phosphate family of glasses. The insulating, outer clad glass 180 of the fused fiber may be a glass that is much less etchable in acid than the bulk conducting core glass. A suitable clad glass, would be, for example, an alumina phosphate glass. Various other common oxides may also be added in smaller amounts to modify the properties of this glass in ways well known to persons skilled in the art. In a fused fiber, between the center core glass 160 and the outer clad glass 180 is a third etchable, inner clad glass 170 that is substantially more etchable in acid than the insulating clad glass 180. An inner clad glass 170 that is at least 1000 times more etchable in acid than the insulating clad glass would be a suitable for use in the present invention. Each fused fiber 114 has a thin emission tip 120. FIG. 3 shows an example of how the emitter tips 120, spacers 121 and the etchable inner clad glass 170 would appear following etching of this type of structure. As can be seen, the etch of inner clad glass 170 produces a meniscus shaped upper portion 91.

The center core element 160 has an emitter tip 120 formed on its upper portion. The emission tip 120 can act alone as an emission because of its bulk conducting properties and its sufficiently small size. Emission tip 120 is recessed within an upper portion 121 of outer clad glass 180. Emission tip 120 extends upwardly relative to the upper portion of inner clad glass 170. The upper portion 121 of clad glass 180 also serves as spacer to separate emission tip 120 from faceplate 3. Emission tip 120 can be used as a base for deposition of other low work function material that could act as multiple emission points. In the embodiment of FIG. 3, the bulk conducting central core elements can be electrically charged during the vacuum deposition to selectively deposit this material onto the core elements.

The Construction of Array

The following details are for the construction of a suitable array for use in making an FED according to the embodiment of FIG. 3.

i) Conductive central core: A bulk conductive glass (for example, a vanadium-iron-lead-phosphate glass with a bulk resistivity of approximately 5×10⁹ ohm-cm). The resistivity of the glass can be adjusted by changing the percentages of iron and vanadium oxide in the glass composition.

ii) Non-conductive outer clad: An alumina phosphate glass with thermal expansion and softening point that nearly match the bulk conductive core glass.

iii) Etchable inner clad (where applicable): A glass which can be dissolved in acid with a speed no more than two times faster than the bulk conducting core glass and with a speed of at least 1000 times faster than the insulating outer clad glass. The coefficient of expansion of the etchable inner clad glass should nearly match both the core and the outer clad glasses. Then a relatively rapid change of viscosity with temperature will allow the whole assembly to stay rigid during the final sintering process while the more fluid outer clad glass will deform to fill the interstices between the fibers.

Processing of an FED Array

The following details are for the processing of an FED array according to the embodiment of FIG. 3.

i) First draw of bulk conductive core rod/etchable inner clad tube (if applicable)/outer non-conducting clad tube together to form a fiber at a temperature where-the viscosity is in the range of 10⁵ to 10⁶ poise.

ii) Packing of single fibers together in an ordered array of approximately 2000-5000 fibers. The pack may be in a hexagonal form.

iii) A second draw of the pack of fibers at a temperature where the viscosity is in the range of 10⁶ to 10⁷ poise.

iv) Packing of the second drawn fiber canes together into a surrounding glass tubing device that holds the canes together in a desired plate shape.

V) Sintering the fibers and tubing under vacuum.

vi) Slicing the sintered boule to a wafer form approximately 2 mm thick.

vii) Grinding and polishing both sides of the wafer.

viii) Sealing one side of the wafer with wax or other etch-resistant resists.

ix) Soaking and vibrating the wafer in a dilute acid solution to remove the bulk conductive glass within each clad channel to the desired depth. In the first embodiment of this invention, this etching also forms the conical shaped emission tip at the top of the bulk conducting core. In the second embodiment of this invention, this etching removes the bulk conducting central core glass within each channel to the desired depth and also the etchable inner core glass to beyond the central core glass desired depth.

x) Cleaning out the channels by rinsing with distilled or deionized water.

xi) Cleaning up the wafer by removing the wax or resist layer.

Bulk Conducting Glass Compositions

Bulk conducting glass compositions suitable for use in the present invention are described in U.S. patent application Ser. No. 09/086,717 filed May 28, 1998, issued Aug. 15, 2000 as U.S. Pat. No. 6,103,648, which is hereby incorporated by reference as is set forth in its entirety herein. As used herein, including in the attached claims, reference to glass compositions having particular mole % values for ingredients is intended to refer to the mole percentages of the starting ingredients used for glass formation. It is generally the case that the compositional percentages are substantially maintained in the formed glass. It is also intended that references to a particular oxide mean that particular oxide or an equivalent oxide for maintaining the same ratio of elements in the glass composition.

The novel phosphate glass bulk conductive glasses of the present invention are suitable for commercial applications. They fall within the family of glasses represented by PbO—FeO—V₂O₅—P₂O₅. The compositions of this invention include P₂O₅ and V₂O₅ with the ratio of the mole percentage of P₂O₅ to V₂O₅ (P₂O₅/V₂O₅) being in the range about 1 to 7, and the P₂O₅ and V₂O₅ being present in the composition in an aggregate amount of at least 50 mole %.

The composition of this invention should also include an appropriate amount of an iron oxide to contribute to the conductive properties of the glass. It is preferred that compositions made according to this invention include FeO in an amount of up to about 20 mole %. Both FeO and V₂O₅ are necessary components of this invention.

This invention also contemplates compositions where PbO is also a necessary component. PbO is added to the composition to improve the workability of the glass and to permit the glass to be drawn into fibers. A part of the PbO may be substituted by BaO and/or other alkali earth oxides such as CaO and MgO and/or also by ZnO. Preferably the sum of these modifying oxides is at least 15 mole %.

In another variation of this invention, Al₂O₃ may be added to these compositions up to about 15% of the total mole % of P₂O₅. The addition of Al₂O₃ to the phosphate glass will increase the three-dimensional network structure and improve the stability of the glass against devitrification.

As another novel feature of this invention, adding a small amount of Mn⁺³/Mn⁺² as MnO or Sb⁺⁵/Sb⁺³ as Sb₂O₃ to the composition is believed to stabilize the conductive behavior of the glass. With one or both ingredients, the composition is less affected by processing conditions such as variations in temperature and atmosphere. Preferred amounts of one or both of these oxide ingredients range from 0 to 1 mole %.

To help confirm that glasses with appropriate properties could be formed according to this invention, glasses in the following Table were melted and measured. The Table below shows the oxide compositions of glasses in mole percent. The Table also shows measured glass properties. These include the Coefficient of Thermal Expansion (CTE)×10⁷ cm/cm/° C. over the range 25-300° C., the Littleton Softening Point temperature, the Transformation Temperature T_{g}, and the DC Resistivity in ohms-cm. Examples 1-5 are bulk conducting core glasses within the scope of the invention. Examples 6-8 are compatible non-conducting outer clad glasses, Examples 9-11 are compatible etchable inner clad glasses.

TABLE 1
EXAMPLES 1-11
TABLE

| | | | | | | | | | | | |
|---|---|---|---|---|---|---|---|---|---|---|---|
| EXAMPLE | 1 | 2 | 3 | 4 | 5 | 6 | 7 | 8 | 9 | 10 | 11 |

COMPOSITION (MOLE %)

| | | | | | | | | | | | |
|---|---|---|---|---|---|---|---|---|---|---|---|
| P₂O₅ | 55.70 | 38.00 | 45.00 | 52.90 | 49.55 | 56.00 | 55.30 | 62.90 | 50.00 | | 52.60 |
| V₂O₅ | 10.45 | 33.00 | 14.00 | 9.70 | 9.30 | | 1.10 | 4.05 | | | |
| B₂O₃ | | | | | | | | | | 62.50 | 21.60 |
| FEO | 11.90 | 12.00 | 19.00 | 9.40 | 10.20 | 9.00 | | | | | |
| PBO | 20.95 | 17.00 | 21.00 | 6.30 | 18.50 | 18.50 | 2.00 | 13.00 | | | |
| AL₂O₃ | | | | 6.20 | 0.90 | | 8.00 | 0.95 | | 5.50 | |
| CAO | | | | 4.00 | | | 11.80 | | | 12.00 | |
| MGO | | | | 4.00 | | | 10.10 | | | | |
| BAO | | | | 3.30 | | | 4.20 | | | 17.40 | |
| Y₂O₃ | | | | | | | 1.00 | | | | |
| CS₂O | | | | | | | | | | 2.50 | |
| ZNO | | | | 3.20 | 10.30 | 10.00 | 6.30 | 18.20 | 50.00 | | 25.60 |
| COO | | | | | | 2.00 | | | | | |
| NIO | | | | | | 2.00 | | | | | |
| MNO₂ | 0.50 | | 1.00 | 0.50 | 0.35 | | | | | | |
| SB₂O₃ | 0.50 | | | 0.50 | 0.90 | 2.50 | 0.20 | 0.90 | | 0.10 | 0.20 |

PROPERTIES

| | | | | | | | | | | | |
|---|---|---|---|---|---|---|---|---|---|---|---|
| CTE | 87 | 81 | — | 76 | 82 | 90 | 74 | — | 86 | 85 | — |
| SOFTENING | 592 | 450 | — | 668 | 592 | 591 | 652 | — | 588 | — | — |
| POINT | | | | | | | | | | | |
| TG | 482 | 410 | — | 537 | — | — | 534 | — | — | — | — |
| RESISTIVITY | 5 × 10⁹ | 5 × 10^{′} | 9 × 10⁹ | 8 × 10⁹ | 3 × 10⁹ | — | — | — | — | — | — |

### EXAMPLE 12

The following example in TABLE 2 is for a range of compositions that are believed to be useful to produce a BC glass as a sensor of high-energy signal flux. (Conventional surface conducting glasses are known to burn out when used as sensors for high-energy signal flux.):

TABLE 2
TABLE

| CHEMICAL | |
|---|---|
| COMPOSITION | MOLE % |
| P2O5 | 38-56 |
| V2O5 | 9-33 |
| FEO | 9-19 |
| PBO + BAO + CAO | 17-29 |
| + MGO + ZNO | |

The components used in the compositions of this invention may be prepared from appropriate raw materials in proportions to supply specific amounts of oxide components by standard melting practices. Glass is obtained by melting a mixture of the relevant oxides in a crucible, according to standard, known techniques. In general, glass is melted by mixing the ingredients and melting them in a crucible. Suitable crucibles for melting phosphate glasses include zirconia, kyanite, SiO₂, and ceramic crucibles.

The BC glass compositions may be drawn into fibers, assembled, and fused into microchannel plates using standard techniques. For example, such techniques are described in U.S. Pat. Nos. 5,015,909 and 5,108,961, which are hereby incorporated by reference as if set forth herein in their entireties.

The foregoing embodiments and features are for illustrative purposes and are not intended to be limiting persons skilled in the art capable of appreciating other embodiments from the scope and spirit of the foregoing teachings.

What is claimed:

1. A field emission wafer formed from an array of glass fibers, a plurality of fibers in the array each comprising an inner core glass of a bulk conductive glass and a clad glass that surrounds the core glass, the conductivity of the core glass being substantially higher than the clad glass, the core glass of the fibers having an upper portion with an emission tip formed thereon.

2. The field emission wafer of claim 1 wherein the conductivity of the core glass to the clad glass is at least about 1000:1.

3. The field emission device of claim 1 wherein the bulk conductive glass composition includes P₂O₅ and V₂O₅, the ratio of the mole percentage of P₂O₅ to V₂O₅ being in the range of about 1 to about 7, and the P₂O₅ and V₂O₅ being present in the composition in an aggregate amount of at least about 50 mole %.

4. The field emission wafer of claim 1 wherein the bulk conductive glass is a composition comprising: P₂O₅, V₂O₅, PbO, BaO, CaO, MgO, ZnO and FeO, the ratio of the molar percentage of P₂O₅ to V₂O₅ being in the range of about 1 to about 6, and the P₂O₅ and V₂O₅ being present in an aggregate amount of at least about 50 Mole %, the PbO+BaO+CaO+MgO+ZnO being present in the glass in an amount in excess of 15 Mole %, and the FeO being present in an amount of up to about 20 Mole %.

5. The field emission wafer of claim 3 wherein the composition includes FeO in an amount of at least about 10 to about 20 Mole %.

6. The field emission wafer of claim 4 wherein in the glass composition the PbO+BaO+CaO+MgO+ZnO is present in an amount of about 15 to about 30 Mole %.

7. The field emission wafer of claim 3 wherein the composition includes PbO in an amount of about 15 to about 30 Mole %.

8. The field emission wafer of claim 1 wherein the bulk conductive glass composition comprises the following components in about the following Mole %: P₂O₅ 38-63%; V₂O₅ 1-33%; FeO 9-19%; and PbO+BaO+CaO+MgO+ZnO 15-30%.

9. A field emission display comprising a faceplate and an opposing base plate, the is base plate comprising a field emission wafer formed of an array of glass fibers, a plurality of fibers in the array each comprising an inner core glass of a bulk conductive glass and a clad glass that surrounds the core glass, the conductivity of the core glass being substantially higher than the clad glass, the core glass of the fibers having an upper portion with an emission tip formed thereon.

10. A field emission display comprising a faceplate and an opposing base plate, the base plate comprising a n array o f glass fibers, a plurality of fibers in the array each comprising an inner core glass of bulk conductive glass with electrical resistivity in the range of 10⁷ to 10¹³ ohm-cm, and clad glass that surround the core glass, the ratio of conductivity between the core glass to the clad glass being greater than about 1000:1.

11. The field emission display of claim 9 wherein the bulk conducting glass is a glass composition comprising the following components in about the following Mole %: P₂O₅ 38-56%; V₂O₅ 7-33%; FeO 10-20%; and PbO 15-30%.

12. The field emission display of claim 9 wherein the bulk conductive is a composition comprising the following components: P₂O₅, V₂O₅, PbO, FeO, and at least one of MnO and Sb₂O₃ in amounts sufficient to produce a glass having bulk conductivity.

13. The field emission display of claim 12 wherein the glass composition includes at least one of MnO and Sb₂O₃ is present in a range of about 0.25 to about 2.0 Mole %.

14. A field emission wafer comprising an array of glass fibers for use in field emission display, a plurality of fibers in the array each comprising a core glass and a clad glass that surrounds the core glass, the core glass in the fibers having an upper portion with an emission tip formed thereon, the emission tip being recessed relative to a surrounding clad glass, the core glass being a bulk conductive glass.

15. The field emission wafer of claims 14 wherein the emission tip has a pointed end.

16. The field emission wafer of claims 14 wherein the clad glass above the recessed tip comprises a spacer for separating the emission tip from baseplate.

17. A field emission display comprising a faceplate and an opposing baseplate, the base plate comprising a field emission wafer formed of an array of glass fibers for use in field emission display, a plurality of fibers in the array each comprising a core glass and a clad glass that surrounds the core glass, the core glass in a fiber having an upper portion with an emission tip formed thereon, the emission tip being recessed relative to a surrounding clad glass, the core glass being a bulk conductive glass.

18. The field emission display of claim 17 wherein the emission tip has a pointed end.

19. The field emission display of claim 17 wherein the clad glass above the recessed tip comprises a spacer that separates the emission tip from the baseplate.

20. A field emission wafer formed of an array of glass fibers, a plurality of fibers in the array each comprising an inner core glass of a bulk conductive glass; an inner clad glass, and an outer clad glass that surrounds the core glass, the core glass of a fiber having an emission tip formed thereon and being recessed relative to the surrounding outer clad glass and extending relative to the inner clad glass.

21. The field emission wafer of claim 20 wherein the inner clad glass is more etchable in acid than the bulk conductive glass and with a speed substantially more etchable than the outer clad glass so that the emission tip is recessed relative to the surrounding outer clad glass and extending relative to the inner clad glass.

22. The field emission wafer of claim 21 wherein the inner clad glass is etchable in acid at a speed no more than about 2 times faster than the bulk conductive glass and with a speed of at least about 1000 times faster than the outer clad glass.

23. The field emission wafer of claim 20 wherein the bulk conductive glass is a vanadium-iron-phosphate glass.

24. The field emission wafer of claim 24 wherein the inner clad glass is an alumina-borosilicate glass that is etchable at least about 500 times faster than the core and outer clad glass.

25. A field emission display comprising a face plate and an opposing base plate, the base plate comprising a wafer formed of an array of glass fibers, a plurality of fibers in the array each comprising a core glass, an inner clad glass, and an outer non-conductive clad glass, the inner core glass in a fiber having an upper portion having an emission tip formed thereon that is recessed relative to surrounding outer clad glass clad glass and extending relative to surrounding inner clad glass, the core glass being a bulk conductive glass.

26. The field emission display wafer of claim 25 wherein the emission tip has a substantially blunt end.

27. The field emission display of claim 25 wherein the outer clad glass above the recessed emission tip comprises a spacer for separating the emission tip from the faceplate.

28. The field emission display of claim 25 wherein the bulk conducting glass is a vanadium-iron-phosphate glass.

29. The field emission display of claim 25 wherein the ratio of conductivity between the core glass to the inner clad glass is at least about 1000:1.

30. The field emission display of claim 29 wherein the inner clad glass is a borate glass that etches in an acid at least about 500 times faster than the outer clad glass and substantially less faster than the core glass.

31. A base plate for a field emission display, the base plate comprising an array of emission tips, the emission tips comprising a bulk conductive glass.

32. The base plate of claim 31 wherein the base plate further includes spacers formed integrally therewith.

33. A base plate for a field emission device wherein the base plate has a surface comprising an array of glass fiber ends, a plurality of the fibers comprising a bulk conducting core glass and a surrounding clad glass, the fibers each having an upper portion terminating in an emission tip formed of the bulk conductive glass.

34. The base plate of claim 33 wherein the upper portion of the fibers further includes a glass spacer surrounding and extending above an emission tip.

35. A field emission display comprising a face plate and a base plate wherein the base plate has a surface comprising an array of fused fibers, a plurality of the fibers each comprising a bulk conductive core glass and a surrounding clad glass, the fused fibers each having an upper portion terminating in an emission tip formed of the bulk conducting core and wherein the upper portion of the fibers includes a spacer formed of the clad glass surrounding and extending above an emission tip.

36. The base plate of claim 33 wherein the fiber has an inner clad glass and an outer clad glass, the inner clad class being recessed relative to the emission tip, the emission tip being recessed relative to the outer clad glass.

37. The field emission display of claim 35 wherein a fused fiber has an inner clad glass and an outer clad glass, the inner clad class being recessed relative to the emission tip, the emission tip being recessed relative to the outer clad glass.

38. A method of making a field emission wafer comprising: providing an array of fused glass fibers in the form of a wafer, a plurality of the fibers in the array each comprising an inner core glass of a bulk conductive glass; a surrounding clad glass; applying an etchant to a surface of the wafer, the etchant being selected to preferentially etch the core glass relative to surrounding clad glass so as to produce an emission tip of core glass that is recessed relative to a surrounding clad glass; allowing the etchant to act until emission tips are formed on a surface of the wafer.

39. The method of claim 38 wherein the core glass is at least about 1000 times more conductive than the clad glass.

40. The method of claim 38 wherein the etchant is allowed to act until emission tips and spacers are produced on a surface of the wafer.

41. A method of making a field emission display comprising: providing an array of glass fibers in the form of a wafer, a plurality of fibers in the array each comprising a core glass, an inner clad glass, and an outer clad glass, the core glass being a bulk conductive glass with resistivity in the range of 10⁷ to 10¹³ ohm-cm, the ratio of conductivity between the core glass to the clad glass being greater than 1000: 1, applying an etchant to a surface of the wafer, the etchant being selected to preferentially etch the inner clad glass relative to the outer clad glass and the core glass, and allowing the etchant to etch the surface so as to produce an emission tip of core glass that is recessed relative to the outer clad glass and extending relative to the inner clad glass.

42. A glass fiber comprising an inner core glass of a bulk conductive glass and a clad glass that surrounds the core glass, the conductivity of the core glass being substantially higher than the clad glass, the core glass of the fibers having an upper portion with an emission tip formed thereon.

43. The field emission wafer of claim 1 wherein the surrounding clad glass comprises an outer clad glass in a fiber comprising a core bulk conductive glass, a inner clad glass surrounding the core glass and the outer clad glass surrounding the inner clad glass and the core glass.
